(19) United States
(12) Patent Application Publication
(10) Pub. No.: US 2023/0211320 A1
(43) Pub. Date: Jul. 6, 2023

(54) THREE-PHASE CATALYTIC SYSTEMS

(71) Applicant: The Board of Trustees of the Leland Stanford Junior University, Stanford, CA (US)

(72) Inventors: Yi Cui, Stanford, CA (US); Jinwei Xu, Stanford, CA (US); Xin Xiao, Stanford, CA (US)

(21) Appl. No.: 17/998,246

(22) PCT Filed: May 7, 2021
(86) PCT No.: PCT/US21/31424

§ 371 Date: Nov. 8, 2022

Related U.S. Application Data
(60) Provisional application No. 63/022,260, filed on May 8, 2020.

(51) Int. Cl. B01J 23/42; B01J 35/10; B01J 35/02

(52) U.S. Cl. CPC B01J 23/42; B01J 35/1052; B01J 35/023

(57) ABSTRACT

A catalyst system includes a porous polymeric base, a nanoscale metal catalyst layer disposed on the porous polymeric base, and a nanoscale electrolyte layer disposed on the metal catalyst layer. The catalyst system is used in methods to perform three-phase catalytic reactions.

### CROSS-REFERENCES TO RELATED APPLICATIONS

This application is a national stage entry of Patent Cooperation Treaty Application No. PCT/US2021/031424 filed May 7, 2021, entitled “THREE-PHASE CATALYTIC SYSTEMS,” which claims priority U.S. Provisional Patent Application No. 63/022,260, filed May 8, 2020, entitled “DESIGNING A NANOSCALE THREE-PHASE ELECTROCHEMICAL PATHWAY TO PROMOTE PT-CATALYZED FORMALDEHYDE OXIDATION,” the disclosures of which are incorporated herein by reference in their entirety.

### FIELD

The subject matter disclosed herein relates to chemical catalytic systems and, in particular, heterogeneous chemical catalyst systems.

### BACKGROUND

Two-phase heterogeneous catalytic systems are typically characterized by chemical reaction at a two-phase interface, such as gas-solid or liquid-solid interface, at which interface adsorption, diffusion, and reaction events take place. As a nominally two-dimensional system, the rates of reaction are limited by surface diffusion.

### SUMMARY

In some aspects, there is provided a catalyst system including a porous polymeric base, a nanoscale metal catalyst layer disposed on the porous polymeric base, and a nanoscale electrolyte layer disposed on the metal catalyst layer.

In some aspects, there is provided a method of performing a three-phase catalytic reaction comprising providing a catalyst system including a porous polymeric base, a nanoscale metal catalyst layer disposed on the porous polymeric base, and a nanoscale electrolyte layer disposed on the metal catalyst layer; and delivering one or more reactants to the catalyst system.

In some aspects, there is provided a method of oxidation comprising providing a catalyst system comprising a porous polymeric base, a nanoscale platinum catalyst layer disposed on the porous polymeric base, and a nanoscale electrolyte layer disposed on the platinum catalyst layer, and delivering oxygen and a substrate for oxidation to the catalyst system.

### DESCRIPTION OF DRAWINGS

FIG. 1 shows a side-view of a catalyst system, in accordance with some embodiments herein.

FIG. 2 shows a side-view at an angle of a catalyst system, in accordance with some embodiments herein.

FIG. 3 shows an encased catalyst system in accordance with some embodiments herein.

FIG. 4a shows conventional heterogeneous catalysis involves adsorption, diffusion, reaction, and desorption, constrained on a two-dimensional surface.

FIG. 4b shows three-phase catalysis, in accordance with some embodiments herein.

FIG. 5 shows a schematic of a Pt-nanopolyethylene (PE) membrane separating air from electrolyte, with the triple-phase contact lines pinned at the hydrophilic-hydrophobic boundaries (e.g., the platinum-polyethylene boundaries).

FIG. 6 shows a scanning electron microscope (SEM) image of a platinum-nanopolyethylene membrane with a pore size ranging from 50 to 1,000 nm.

FIG. 7a shows a schematic of a fixed-bed type reactor with gas phase introduced proximal to the porous polyethylene membrane.

FIG. 7b shows a plot of concentrations of formaldehyde in outlet gas plotted against the duration of experiment with the fixed-bed type reactor of FIG. 6a with a membrane area of 6 cm².

FIG. 7c shows a schematic of a stirred-tank type reactor.

FIG. 7d shows a plot of concentrations of formaldehyde in electrolyte plotted against the duration of experiments with the stirred-tank type reactor of FIG. 6C with a membrane area of 3 cm².

FIG. 8 shows a graph indicating a quantitative comparison of the degradation kinetics.

### DETAILED DESCRIPTION

The present embodiments provide gas-phase heterogeneous catalysis is a process spatially constrained on the two-dimensional surface of a solid catalyst 1-3. In some example embodiments, there is provided a third phase thereby improving reaction kinetics. Herein, there is introduced a new toolkit to open up the third dimension: the activity of a solid catalyst can be dramatically promoted by covering its surface with a nanoscale-thin layer of liquid electrolyte while maintaining efficient delivery of gas reactants, a strategy referred to herein as “three-phase catalysis”. Introducing the liquid electrolyte converts the original surface catalytic reaction into an electrochemical pathway with mass transfer facilitated by free ions in a three-dimensional space. This concept of three-phase catalysis is made possible by using a platinum-coated nanoporous polyethylene membrane which offers ample triple-phase contact lines that are robust to evaporation and stably pinned at the nanostructured hydrophilic-hydrophobic boundaries. Embodiments herein allow for the conversion of a two-dimensional heterogeneous catalyst system into a three-phase, three-dimensional system comprising a gas, liquid, and solid phase.

Unless specifically indicated otherwise, all technical and scientific terms used herein have the same meaning as commonly understood by those of ordinary skill in the art to which this invention belongs. In addition, any method or material similar or equivalent to a method or material described herein can be used in the practice of the present invention. For purposes of the present invention, the following terms are defined.

“Nanoscale,” as used herein, refers to a range of scale materials from 0.5 to 1,000 nm in at least one dimension.

“Catalyst system,” as used herein, refers to the ensemble of a porous polymeric material in direct contact with a catalyst, and an electrolyte liquid layer disposed over the catalyst. This trilayer is the basic unit of a catalyst system.

“Catalyst,” as used herein, refers to any material capable of catalyzing a chemical reaction. Catalysts include metals, such as aluminium, transition metals and the like in zero valent form or in higher oxidation states, and any combinations such materials. Examples include zero-valent platinum, aluminum oxide, platinum oxide, zero-valent palladium, and the like.

“Porous,” as used herein in reference to polymer base materials, refers to a polymeric material that has a porosity in a range from at least 10 nm up to 10 microns, although the upper boundary can be higher provide that the porous polymer base has the ability, when used in combination with the coated catalyst material, to retain the electrolyte layer, in accordance with embodiments herein.

“Electrolyte layer,” as used herein, generally refers to aqueous solutions having solubilized electrolytes, such as salts of alkali metals or alkaline earth metals and increasing the polarity of the aqueous phase.

In some embodiments, there is provided a catalyst system comprising a porous polymeric base, a nanoscale metal catalyst layer disposed on the porous polymeric base, and a nanoscale electrolyte layer disposed on the metal catalyst layer.

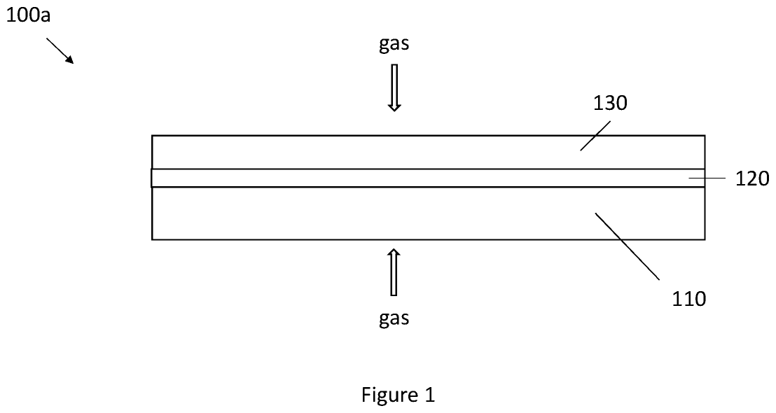

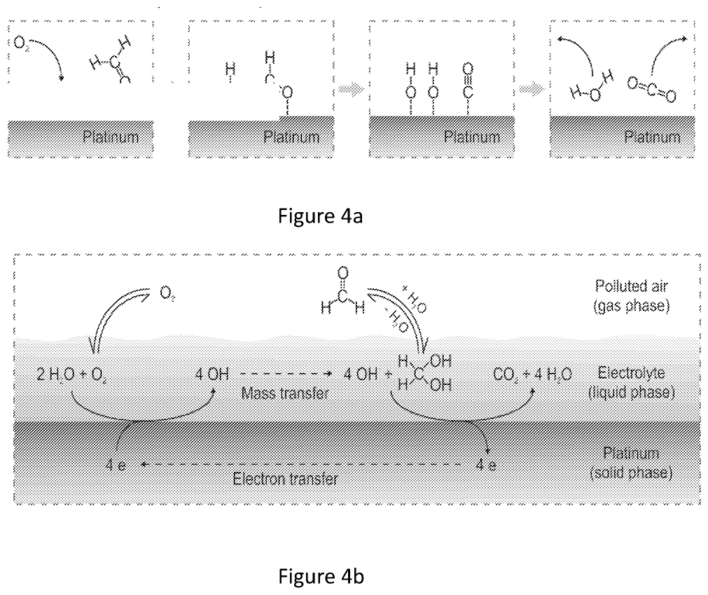

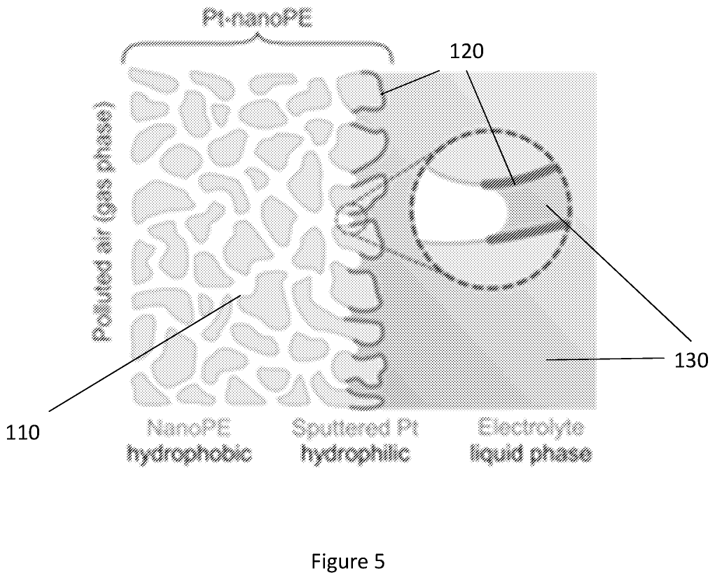

Referring now to FIG. 1, there is shown a side view of a catalyst system 100a in accordance with some embodiments herein. Catalyst system 100a includes three layers, a porous polymer base 110, a nanoscale metal catalyst layer 120 disposed on porous polymer base 110, and an electrolyte layer 130 disposed on nanoscale metal catalyst layer 120. As shown in greater focus in FIG. 4, the nanoscale catalyst layer 120 may itself be porous, such as by roughly conforming to the porous surface of porous polymer base 110. As indicated in the inset of FIG. 5, electrolyte layer 130 can gain access to the gas phase in the porous polymer base at the interface between the hydrophobic porous polymer base (polyethylene in the example of FIG. 5, though it may be any hydrophobic polymer) and the hydrophilic catalyst (indicated as sputtered platinum, Pt in this example, though it can be any hydrophilic catalyst). This arrangement sets up an effective three-phase catalytic system comprising a gas phase, liquid phase, and solid phase at the interface of the three layer catalyst system 100a.

Referring again to FIG. 1, the catalyst system 100a can be configured to introduce gas through electrolyte layer 130, porous polymer base 110, or both. In some embodiments, the reacting components in a chemical reaction can thus be introduced through both sides of the catalyst system. In some embodiments, the liquid phase can also carry other liquid phase reactant materials.

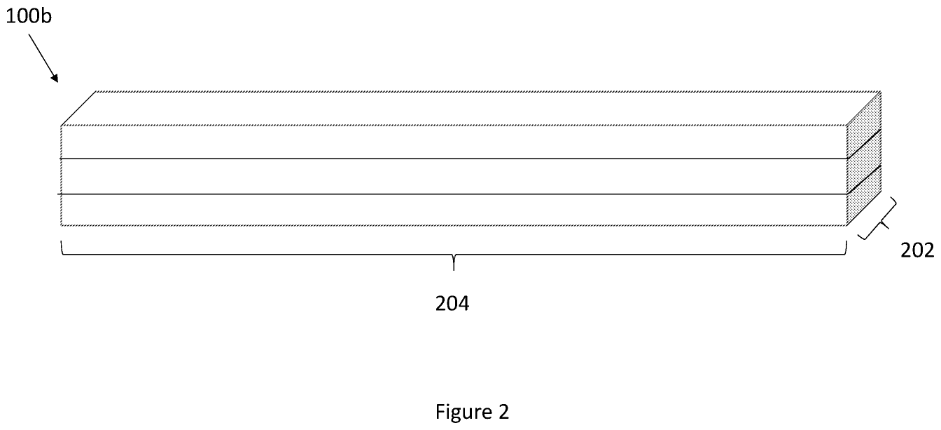

Referring now to FIG. 2, there is shown an angled side view of catalyst system 100b, which indicate side dimensions 202 and 204 in the plane of the catalyst system, which can range in any size from mm to tens of meters. As will be discuss further below, any potential challenges of scale can be addressed through the use of multiple blocks of smaller dimension catalyst systems. In some embodiments, dimension 202 is in millimeters and dimension 204 is in centimeters. In some embodiments dimension 202 is in centimeters and dimension 204 is in centimeters. In some embodiments, dimension 202 and dimension 204 are both on the order of meters.

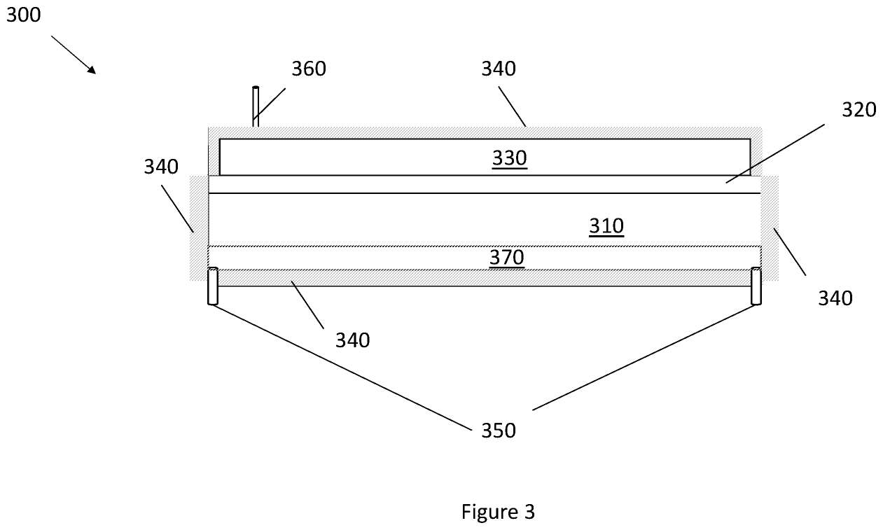

Referring now to FIG. 3, there is shown an encased catalyst system 300, in accordance with some example embodiments. The encased catalyst system comprises a porous polymer base 310, a nanoscale metal catalyst layer 320 disposed on porous polymer base 310 and a nanoscale electrolyte layer 330. Encasement is provided by, for example, retaining walls 340 (which can be made of any material suitable for the conditions under which catalyst system 300 operates), although other types of encasement mechanisms may be used as well. The encasement material may be a gas impermeable plastic or metal casing, for example. Retaining walls 340 can be selected that are inert to the reactant materials that will be used in the system and can also take into account reaction conditions, such as high pressure and or temperature conditions.

Encased catalyst system 300 can be equipped with one or more ports 350 which can serve as gas inlets and/or gas outlets disposed on the side of the catalyst system and proximal to porous polymer base 310. Likewise, one or more optional ports 360 can be equipped at the electrolyte layer side 330, which can be used to fill and/or flow an electrolyte through the cavity created by retaining walls 340, where electrolyte layer 330 has a volume (e.g., dimensions) thereby determined by selection of the dimensions of retaining walls 340. In some embodiments, ports 360 may be placed at the two termini of the gas chamber, so that the gas can flow through cavity 370.

Retaining walls 340 also define cavity 370 through which gas materials can be introduced proximal to porous polymeric base 310. Although shown in rectangular form (prism in 3 dimensions), it is possible to shape cavity 370 in other configurations, such as oval.

The porous polymeric base of the catalysts systems can have any thickness that still permits sufficient flow of a gaseous reactant to the interface with the catalyst and electrolyte. In some embodiments, the porous polymeric base has a thickness in a range from 100 nm to 100 microns, including any sub-ranges thereof. In some embodiments, the porous polymeric base has a thickness in a range from 100 nm to 100 microns. In some embodiments, the porous polymeric base has a thickness in a range from 100 nm to 20 microns thick. In some embodiments, the porous polymeric base has a thickness in a range from 500 nm to 10 microns thick. In some embodiments, the porous polymeric base has a thickness in a range from 1 micron to 5 microns thick.

The porous polymeric base can have pores of any size consistent with effective flow of gas to the reaction interface as well as effectively retaining the electrolyte layer. In some embodiments, the porous polymeric base comprises a pore size in a range from 10 nm to 10 microns, including sub-ranges thereof. In some embodiments the porous polymeric base comprises a pore size in a range from 10 nm to 10 microns. In some embodiments, the porous polymeric base comprises a pore size in a range from 50 nm to 1,000 nm. In some embodiments, the porous polymeric base comprises a pore size in a range from 10 nm to 500 microns.

The porous polymer base can be made of any porous polymer. Some polymers may be porous by virtue of their preparation conditions and are well-known in the art. Such polymeric materials may be naturally occurring polymers or synthetic polymers. Hydrophobic polymers may be based on acrylates, amides, imides, carbonates, dienes, polyesters, polyethers, fluorocarbons, olefins, styrenes, vinyl esters, vinyl ethers or ketones, and any other polymer compatible with the chemistry of the catalyst system and the ability to form stable porous material. In some embodiments, the porous polymer is fabricated as a porous membrane.

The porous polymer base can be fabricated through any method known in the art. For example, the porous polymer base can be fabricated via woven or non-woven fibers of the polymer material. In some embodiments, the porous polymer base can be fabricated from polymer emulsions.

In some embodiments, the porous polymeric base comprises polyethylene, polypropylene, polysulfone, polyimide, polyacrylonitrile, polyvinyl chloride, polyvinylidene fluoride, polyvinyl acetate, polytetrafluoroethylene, or a cellulose, especially hydrophobized cellulose. The exact selection of the polymer is guided by the gas permeability of the polymer and its porosity to allow reactant materials to the interface between the gas phase, liquid phase at the catalyst polymer interface (see FIG. 4b and FIG. 5).

The nanoscale metal catalyst layer 320 can have any thickness on the nanoscale. In some embodiments, nanoscale metal catalyst layer 320 has a thickness in a range from 1 nm to 100 nm, including any sub-range thereof. In some embodiments, the nanoscale metal catalyst layer 320 has a thickness in a range from 1 nm to 50 nm. In some embodiments, the nanoscale metal catalyst layer 320 has a thickness in a range from 5 nm to 20 nm. In some embodiments, metal catalyst layer is 5 nm, 6 nm, 7 nm, 8 nm, 9 nm, 10 nm, 11 nm, 12, nm, 13, nm, 14 nm, or 15 nm, including fractions thereof. As the metal catalyst will typically be sputtered onto the surface of the porous polymer base, an amount of metal catalyst should still provide access to the pores at the interface of the porous polymer base and the catalyst layer.

The nanoscale metal catalyst of layer 320 can be any metal, zero-valent or higher oxidation state, and any combination of metals or alloys. In some embodiments, the catalysts can comprise metal oxides. Examples of metal oxides include titanium dioxide, aluminum oxide, silica, zirconium oxide, cerium oxide, and the like. In some embodiments, the nanoscale metal comprises aluminum. In some embodiments, the nanoscale metal comprises aluminum oxide. In some embodiments, the nanoscale metal catalyst comprises a transition metal. In some embodiments, the transition metal comprises platinum, palladium, copper, rhodium, silver, ruthenium, iridium. In some embodiments, the metal catalyst of layer 320 can be any alloy. In some embodiments, he metal catalyst of layer 320 can be two different metals or alloys that reside in spatially different locations on the surface of the porous polymer base.

The nanoscale electrolyte layer can be any thickness. In some embodiments, the nanoscale electrolyte layer has a thickness in a range from 10 nm to 1,000 nm, including any sub-range thereof. In some embodiments, the nanoscale electrolyte layer has a thickness in a range from 10 nm to 1,000 nm. In some embodiments, the nanoscale electrolyte layer has a thickness in a range from about 10 nm to about 500 nm. In some embodiments, the nanoscale electrolyte layer has a thickness in a range from 50 nm to 300 nm. In some embodiments, the nanoscale electrolyte layer can refer to the electrolyte material that finds its way into the pores of the porous polymer-base, nanoscale metal catalyst layer. Accordingly, the nanoscale electrolyte layer may be in contact with a larger bulk layer of electrolyte material. See for example, the stir-tank reactor example further below.

Any inorganic salt that provides an electrolyte concentration can be used in connection with the electrolyte layer. In some embodiments, the nanoscale electrolyte layer comprises an aqueous solution of a salt of an alkali metal or alkaline earth metal. Salts of sodium, lithium and potassium salts are non-limiting examples.

In some embodiments, the catalyst system is monolithic. Referring again to FIGS. 1 to 3, a catalytic system can comprise a single unit shown as catalyst system 100a and 100b, or encased catalyst system 300, having any dimensions 202 and 204. In some embodiments, the system can comprise a plurality of component catalyst systems, such as encased catalyst system 300. Such units enclosed in a casing to retain the electrolyte layer and at least the porous polymer base may be equipped with a gas inlet and outlet (ports 350) as shown in FIG. 3. When a plurality of units are used together they may be stacked vertically or laid out horizontally. In some embodiments a plurality of units may be placed in series to conduct the same or different chemistries. In some embodiments a plurality of units may be placed in parallel. The selection of dimensions and whether to employ a system in series or parallel can be selected based on the observed kinetics of the system.

In order to effect the introduction of reactant materials into the catalyst system, gas inlets may be provided at any point in the system. In some embodiments, the encased catalyst system 300 comprises one or gas inlets (ports 350, FIG. 3) configured to expose the porous polymer to a gas comprising one or more reactants. In some embodiments the system comprises one or more gas inlets (ports 360, FIG. 3) configured to expose the electrolyte layer to one or more reactants.

In some embodiments, there is provided a method of performing a three-phase catalytic reaction comprising providing a catalyst system comprising a porous polymeric base, a nanoscale metal catalyst layer disposed on the porous polymeric base, and a nanoscale electrolyte layer disposed on the metal catalyst layer, and delivering one or more reactants to the catalyst system. In some embodiments, the catalyst system may be configured to execute the methods in a fixed-bed configuration. In some embodiments, the catalyst system may be configured to execute the methods in a stir-tank reactor configuration. Each of these two configurations are described in the examples below.

In some embodiments, the one or more reactants are delivered proximal to the porous polymer base. In some such embodiments, the one or more reactants may circulated through the catalyst system once or multiple times. In some embodiments, sampling may be taken during cycles through the catalyst system to monitor the progress of the reaction. For example, gas products may be sampled via gas chromatography (GC) or GC-mass spectrometry. In some embodiments, the indication of the end of a particular reaction having a gaseous product may indicate that gas may be circulated to a second catalyst system to perform a different catalytic reaction. In this way, methods disclosed herein may be used to carry out more than one chemical reaction step.

In some embodiments, the one or more reactants can be delivered to the catalyst system via the electrolyte layer. In some embodiments, the one or more reactants in the electrolyte layer may be pre-dissolved. In some embodiments, the one or more reactants can be added to the electrolyte layer in a continuous manner as a gas or a liquid.

In some embodiments, the one reactant is delivered to the catalyst system via the electrolyte layer and another reactant is deliver to the catalyst system proximal to the porous polymer base. As an example, gaseous oxygen may be introduced via the porous polymer base and a reactant partner such as formaldehyde (as shown in the example below) can be introduced via the electrolyte layer.

In some embodiments, there is provided a method of oxidation comprising providing a catalyst system comprising a porous polymeric base, a nanoscale platinum catalyst layer disposed on the porous polymeric base, and a nanoscale electrolyte layer disposed on the platinum catalyst layer, and delivering oxygen and a substrate for oxidation to the catalyst system. In some embodiments, oxygen is delivered proximal to the porous polymeric base.

In some embodiments, the substrate is delivered via the electrolyte layer. The substrate can be any organic or inorganic material for which oxidation of such material is desired. Example of organic substrates include, without limitation, olefins, carbon monoxide, formaldehyde, ammonia, methane, and the like. In some embodiments, the substrate is formaldehyde.

It will be apparent to those skilled in the art, the catalyst systems disclosed herein can be used to carry out a variety of chemical methods based on selection of catalyst material and disposition of reactant materials within the gas phase and/or electrolyte phase. In some embodiments, methods can employ a catalyst to carry out ammonia oxidation. In some embodiments, methods can employ a catalyst to carry out methane oxidation. In some embodiments, methods can employ a catalyst to carry out formaldehyde oxidation. In some embodiments, methods can employ a catalyst to carry out olefin hydrogenation. In some embodiments, method can employ a catalyst to carry out olefin metathesis.

The catalyst systems disclosed herein can be modified to conduct reaction chemistries at controlled temperatures through heating or cooling. The catalyst systems disclosed herein can be modified to conduct reaction chemistries at controlled pressures, including high pressures, such as 1 to 10 atmosphere, or reduced pressures less than 1 atmosphere.

With respect to catalyst preparation, a nanoscale polyethylene (NanoPE) membrane with a thickness of 12 μm may be used (commercially available from Entek International). Platinum (Pt) was deposited via direct-current magnetron sputtering at an applied power of 150 W and a working pressure of 10 mTorr in an Ar atmosphere, for example. The thickness of the Pt coating can be tuned by controlling the sputtering time. For example, a 10-nm-thick Pt coating corresponds to a sputtering time of 30 seconds. For hydrophilic treatment, the nanoPE membrane was treated by oxygen plasma (XEI Scientific Evactron Decontaminator) at an applied power of 14 W with 400 mTorr of O₂ for 5 min, for example.

With respect to the generation of formaldehyde-contaminated air, an apparatus was used for generating formaldehyde-contaminated air. A mass flow controller (commercially available from Alicat Scientific) may be used to control the concentration of formaldehyde in the solution, one can control the concentration of formaldehyde in the outlet gas.

Regarding the quantification of formaldehyde, the quantification of formaldehyde may be carried out via the acetylacetone spectrophotometric method. The mechanism is described by the following reaction. For example, 10 mL of a sample solution was mixed with 2 mL of a stock solution, which contains 0.25% (v/v) acetylacetone (Sigma-Aldrich) and 250 g·L-1 ammonium acetate (Sigma-Aldrich), with pH adjusted to 6 using acetate acid (Sigma-Aldrich). After 12 hours of reaction under room temperature for example, the mixture solution was measured by a high-performance liquid chromatography (HPLC, Agilent 1260) equipped with a UV detector and a SB-C18 column (2.7 μm, 3.0×50 mm, Zorbax Eclipse). In this example, the sample injection volume was 50 μL; isocratic mobile phase contained 30% (v/v) methanol (Fisher Scientific, HPLC grade) and 70% (v/v) water (Fisher Scientific, HPLC grade) under a flow rate of 0.5 mL·min-1; the detector wavelength was set at 415 nm. For quantifying the concentration of formaldehyde in gas samples, a specific amount of a gas sample was swept into an absorber where formaldehyde was trapped by 3 mL of water, for example. The absorber solution was then analyzed by the procedure described above.

With respect to reactor fabrication, the reactors may be assembled from component parts that were made by a laser cutter (e.g., Epilog Fusion M2). Acrylic sheets and EPDM rubber sheets with different thicknesses were purchased from McMaster-Carr.

Regarding materials characterizations, the SEM images were taken using for example a FEI Magellan 400 XHR SEM with an acceleration voltage of 15 kV. For the cross-sectional SEM image, a small piece of Pt-nanoPE membrane was gently torn apart by using two pairs of tweezers in liquid nitrogen, for example. The XPS spectra were collected using a PHI VersaProbe Scanning XPS Microprobe with an Al (Kα) source, for example. The FTIR spectra were measured using a Nicolet iS50 FT/IR spectrometer in the attenuated total reflectance mode, for example. The areal mass loading of Pt on the Pt-nanoPE membrane was measured by for example digesting the samples in aqua regia and then analyzing the digests with an ICP-MS (Thermo Scientific XSeries II).

With respect to dynamic contact angle measurements, the smooth PE surface was obtained by hot-pressing high-density polyethylene (HDPE) (commercially available from Sigma-Aldrich) on a flat glass slide at 100° C., for example. The smooth Pt surface was obtained by magnetron sputtering 100-nm-thick Pt on a flat glass slide, for example. Advancing contact angle and receding contact angle were measured using the needle method on for example, a Contact Angle Goniometer (commercially available from Rame-Hart 290).

The following describes an example related to the oxidation of formaldehyde. The present example provides a model reaction for the three-phase system, in accordance with embodiments herein. In this example, it is demonstrated that the activity of platinum (Pt) for catalyzing the oxidation of formaldehyde can be dramatically promoted by covering the Pt surface with a nanoscale-thin layer of aqueous electrolyte. This strategy of using a solid-liquid binary-phase complex to catalyze a gas-phase reaction is the “three-phase catalysis,” as disclosed herein.

Formaldehyde (CH₂O) is a common indoor air pollutant primarily emitted from pressed wood products used in home construction and furnishings. Platinum is generally considered the most effective catalyst for the oxidative degradation of formaldehyde at room temperature. The catalytic mechanism of Pt is summarized in FIG. 4a. First, O₂ dissociatively adsorbs onto adjacent Pt atoms, yielding two O adatoms. Then, CH₂O is oxidized by an O adatom to form adsorbed formate as an intermediate, followed by decomposition into adsorbed CO and adsorbed OH. Finally, adsorbed CO is oxidized to CO₂ by O adatom, which is replenished by O₂ in the air or regenerated from adsorbed OH. There are two major obstacles hindering the kinetics of such heterogeneous catalytic process: (i) reactive species need to be adsorbed adjacently; otherwise, the reaction is limited by surface diffusion (e.g., the reaction between adsorbed CO and O adatom); (ii) most reactive species are adsorbed with particular configurations, leading to geometric restrictions for some surface reactions to happen (e.g., O adatom is not able to attack the proton on bridge-adsorbed formate; thus, the reaction can only proceed through formate decomposition).

Introducing an electrolyte layer on Pt converts the original chemical reaction between O₂ and CH₂O into two electrically shorted electrochemical reactions (as shown at FIG. 4b). Such conversion solves the two aforementioned problems for conventional heterogeneous catalysis: (i) there is no more need for O₂ and CH₂O to find each other on Pt since the two electrochemical reactions here are electrically connected and can thus be spatially apart; (ii) surface reactions are no longer restricted by adsorption configurations. For example, when hydrated formaldehyde is electrochemically oxidized, H₂O or OH⁻ can attack its protons from any direction in three dimensions to form H₃O⁺ or H₂O, respectively, depending on pH. Similarly, O₂ can receive protons directly from the electrolyte when electrochemically reduced.

Although the presence of salt water accelerates the corrosion of iron, a piece of iron fully immersed in salt water rusts much slower than a half-immersed one, which is due to the low solubility of O₂ (8 ppm). Likewise, introducing an electrolyte layer into heterogeneous catalysis might also be counterproductive because it builds a physical barrier between the gas-phase reactants and the solid-phase catalyst. O₂ and CH₂O need to be dissolved first and then reach the Pt surface by diffusion, which is driven by the concentration gradient. Therefore, the thickness of the electrolyte layer must be minimized; otherwise, reactants with less solubility would be readily depleted, resulting in hindered reaction kinetics.

In this example, the system with Pt catalyst was prepared by depositing 10-nm-thick Pt on one side of a nanoporous polyethylene (nanoPE) membrane through magnetron sputtering. Because Pt is hydrophilic and PE is hydrophobic, when the Pt-deposited side gets in contact with an aqueous electrolyte, as shown in FIG. 5, the electrolyte will spontaneously wet the hydrophilic surfaces (i.e., the surfaces coated with Pt) through capillary action and finally stop at the hydrophilic-hydrophobic boundaries (i.e., the Pt-PE boundaries), while the hydrophobic and interconnected pores of nanoPE remain dry, enabling efficient gas delivery. Such design offers one or more of the following advantages: (i) the aforementioned O₂-depletion problem is alleviated because the amphiphilic nanopores of Pt-nanoPE provide ample triple-phase contact lines (the inset of FIG. 5), where the distance from the gas-liquid menisci to Pt (equivalent to the thickness of the electrolyte layer) is at nanoscale; (ii) water can be continuously supplied to the gas-liquid menisci to compensate for evaporation since a plentiful amount of aqueous electrolyte is stored as a water reservoir with direct connection to the gas-liquid menisci without blocking the gas diffusion pathway; (iii) the triple-phase contact lines are stably pinned at the Pt-PE boundaries within a huge pressure-difference range (−166 kPa<P_{gas}−P_{liquid}<288 kPa) due to Laplace pressure. Such pinning effect provides great ease and flexibility for reactor design in practical applications.

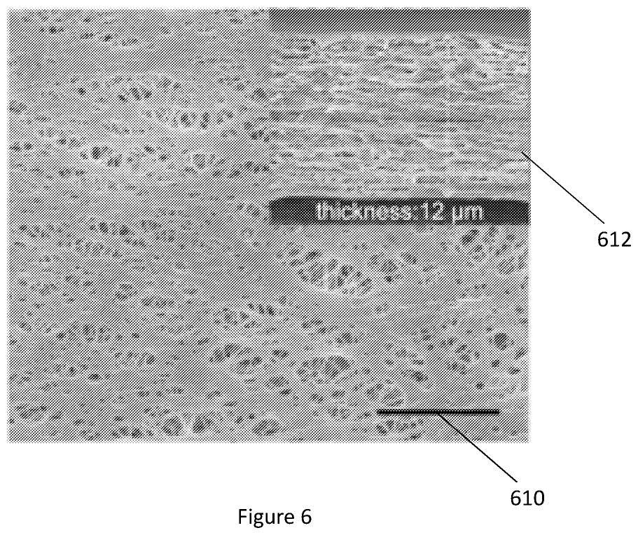

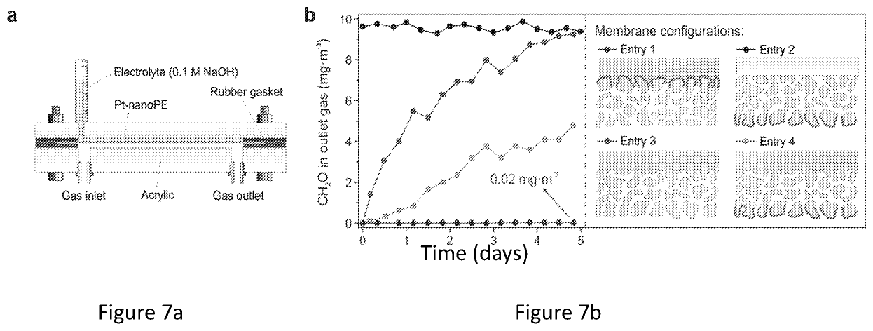

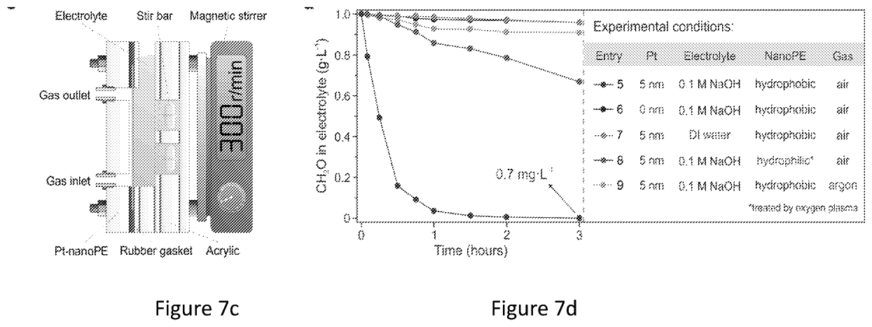

The three-phase catalysis system was benchmarked against conventional heterogeneous catalysis by using a fixed-bed type reactor (as shown at FIG. 7a). The reactor is composed of two chambers. A 6 cm²-large membrane separates the upper chamber, which contains 0.6 mL of 0.1 M NaOH aqueous solution, from the lower chamber, where 10 mg·m⁻³ formaldehyde-contaminated air passes through at a flow rate of 40 mL·min⁻¹. The thicknesses of both chambers are 1 mm 0.3 mL of 0.1 M NaOH is stored in the graduated cylinder with connection to the liquid chamber in order to compensate for evaporation during the tests. A series of experiments were conducted with four different membrane configurations and measured the outlet formaldehyde concentration over 5 days (FIG. 7b). FIG. 7b shows a plot of concentrations of formaldehyde in outlet gas plotted against the duration of experiment with the fixed-bed type reactor of FIG. 6a with a membrane area of 6 cm². Inlet gas, air containing 10 mg·m⁻³ formaldehyde. Gas flow rate, 40 mL·min⁻¹. Electrolyte, 0.1 M NaOH aqueous solution.

For three-phase catalysis (entry 1 in FIG. 7b), a Pt-nanoPE membrane was used with the Pt-coated side facing toward the liquid chamber. The result shows that a 99.8% removal efficiency was kept after 5 days on stream, with an outlet formaldehyde concentration of 0.02 mg/m³, which is well below the WHO indoor air quality guideline⁷ (0.1 mg·m⁻³). For conventional heterogeneous catalysis (entry 2), the Pt-nanoPE membrane in entry 1 was flipped over with the Pt-coated side exposed toward the gas chamber and the PE side sealed by an acrylic sheet. The result shows that less than 10% removal efficiency was achieved, which is much less than that of three-phase catalysis. In order to confirm that the extraordinary performance of three-phase catalysis was not merely due to dissolution, entry 1 was repeated with a nanoPE membrane without Pt coating (entry 3). Not surprisingly, dissolved formaldehyde accumulated in the liquid chamber rather than being oxidized, and finally the dissolution reached equilibrium. In the last experiment of this series, entry 2 was repeated without sealing the PE side (entry 4), which can be regarded as a simple combination of heterogeneous catalysis and dissolution. The poor performance of entry 4 compared to entry 1 corroborates that the synergistic effect between Pt and electrolyte arises from the thoughtfully designed assembly as shown in FIG. 5, where nanoPE plays an essential role. The results of entries 1-4 successfully demonstrate the supremacy of three-phase catalysis over conventional heterogeneous catalysis.

The complexity stemming from the coupling of the dissolution kinetics and the degradation kinetics in the fixed-bed type reactor hinders their quantitative analysis. Therefore, a stirred-tank type reactor (as shown at FIG. 7c) was designed, the major differences of which from the fixed-bed type reactor are: (i) the volume of the liquid chamber is expanded by 10-fold, providing enough solution for sampling; (ii) two magnetic stirrers are added, enabling a homogeneous concentration for quantification. First, the reactor is used to quantitatively measure the thermodynamics and kinetics of the dissolution of formaldehyde in 0.1 M NaOH. Next, the reactor is used to study the effects of Pt, electrolyte, gas composition, etc. on the degradation kinetics of formaldehyde (FIG. 4d). In a typical experiment, formaldehyde was pre-dissolved in the liquid chamber with an initial concentration of 1 g·L⁻¹, and uncontaminated air passed through the gas chamber to deliver O₂. The concentration of formaldehyde in the liquid chamber was measured over 3 hours.

Entry 5 in FIG. 7d is a positive control that represents three-phase catalysis. FIG. 7d shows a plot of concentrations of formaldehyde in electrolyte plotted against the duration of experiments with the stirred-tank type reactor of FIG. 6C with a membrane area of 3 cm². Gas flow rate, 20 mL·min⁻¹. 1 g·L⁻¹ formaldehyde was pre-dissolved in the liquid chamber. As expected, the concentration of formaldehyde rapidly decreased, and merely 0.7 mg·L⁻¹ (i.e., 99.93% removal efficiency) formaldehyde remained in the electrolyte after 3 hours. In entry 6, a nanoPE membrane without Pt coating was used and negligible loss of formaldehyde due to vaporization was observed, indicating the critical catalytic role of Pt. In entry 7, deionized (DI) water was used in place of 0.1 M NaOH and found minimal degradation, suggesting that the electrolyte is crucial for the fast degradation. In entry 8, the nanoPE membrane was treated by O₂ plasma and thus became hydrophilic. As a result, electrolyte flooded all the pores in nanoPE, and the diffusion distance for O₂ in the gas phase to reach Pt increased from nanoscale to 12 μm (the thickness of the nanoPE membrane as shown by the inset of FIG. 6). FIG. 6 shows a scanning electron microscope (SEM) image of a platinum-nanopolyethylene membrane with a pore size ranging from 50 to 1,000 nm. In the example of FIG. 6, the scale bar 610 is 2 μm. The inset image 612 shows a cross-sectional SEM image measuring the thickness of the platinum-nanopolyethylene membrane. The insufficient supply of O₂ slowed down the degradation, justifying the necessity of having the hydrophobic nanoPE to pin the triple-phase contact lines near Pt. In entry 9, argon instead of air passed through the gas chamber. The initial about 10% degradation of formaldehyde was attributed to dissolved O₂, and no more degradation was observed after the dissolved O₂ was consumed, confirming that the degradation of formaldehyde was due to oxidation by O₂. The performance gap between entries 6-9 and entry 5 clearly shows that Pt, electrolyte, hydrophobic nanoPE, and air are indispensable elements for three-phase catalysis.

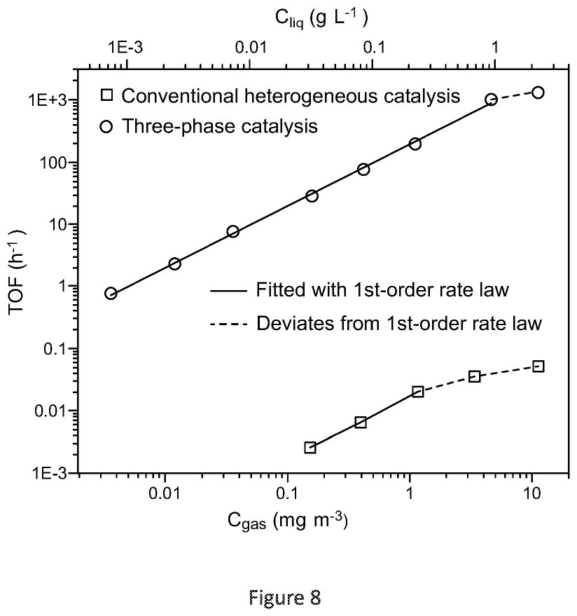

To quantitatively compare three-phase catalysis with conventional heterogeneous catalysis, the turnover frequency (TOF) in both cases at different formaldehyde concentrations (as shown at FIG. 8) was measured. FIG. 8 shows plot indicating a quantitative comparison of the degradation kinetics. Turnover frequency (TOF, moles of formaldehyde converted per mole of Pt per hour) is calculated based on the total metal content. Upper and lower axes represent the concentrations of formaldehyde in 0.1 M NaOH and air, respectively, which are aligned with each other according to Henry's law (i.e., any two concentrations on the two axes vertically aligned are in thermodynamic equilibrium). In the example of FIG. 8, the turnover frequency (TOF, moles of formaldehyde converted per mole of Pt per hour) is calculated based on the total metal content. Upper and lower axes represent the concentrations of formaldehyde in 0.1 M NaOH and air, respectively, which are aligned with each other according to Henry's law (i.e., any two concentrations on the two axes vertically aligned are in thermodynamic equilibrium). Three-phase catalysis promotes the TOF of Pt by 25,000 times as compared to conventional heterogeneous catalysis. Such enhancement is not due to changes in the intrinsic properties of Pt since the Pt in both cases were deposited in the same manner. Indeed, such enhancement presents itself because of the introduction of the electrolyte, which completely changes the catalytic pathway as explicated in previous texts. Another remarkable feature of three-phase catalysis is the excellent fitting of the degradation-kinetics data with 1st-order rate law until a TOF of 1,000 h⁻¹, indicating that 02 delivery is not rate-limiting, which justifies the design of the amphiphilic nanostructure of Pt-nanoPE. On the contrary, the degradation kinetics for conventional heterogeneous catalysis deviates from 1st-order rate law at a TOF of merely 0.02 h⁻¹.

The present example provides a system for promoting heterogeneous catalysis, namely, constructing a nanoscale-thin layer of liquid electrolyte on the surface of a conventional solid catalyst. As demonstrated by some of the experiments noted herein, three-phase catalysis may provide about a 25,000-fold boost in the activity of Pt for catalyzing the oxidation of formaldehyde. Such impressive enhancement indicates a high potential for commercialization, especially considering that Pt is only ˜15,000 times more expensive than aluminum, the most abundant metal on Earth. Indeed, the areal mass loading of Pt on the Pt-nanoPE membrane, confirmed by ICP-MS, is merely 20 μg·cm⁻², that is ˜$5·m². On top of that, nanoPE is widely used in lithium-ion batteries as a separator to prevent electrical shorting and can be mass-produced at an extremely low cost (e.g., about $1·m²). Moreover, high-throughput manufacturing of the Pt-nanoPE membrane is readily achievable since magnetron sputtering can be carried out in a roll-to-roll manner.

In a broader context, the three-phase catalysis is potentially applicable for a variety of heterogeneous catalytic reactions, such as ammonia oxidation, methane functionalization, water-gas shift reaction, and hydrogenation of organic compounds. An important feature of three-phase catalysis is the decoupling of electron transfer and mass transfer, which is enabled by adding a nanoscale-thin layer of electrolyte that converts the original chemical catalytic process into two electrochemical catalytic processes. Therefore, the tremendous amount of published research documenting the electrochemical behavior of diverse small molecules provides a promising foundation for exploring the versatility of three-phase catalysis.

In this present example, there was observed a 25,000-times enhancement in the turnover frequency of Pt in a three-phase catalysis as compared to conventional heterogeneous catalysis. Further application of the three-phase catalysis as a new dimension for catalyst design and applications to further chemical reactions will be appreciated by those skilled in the art.

“A,” “an,” or “the” as used herein, not only include aspects with one member, but also include aspects with more than one member. For instance, the singular forms “a,” “an,” and “the” include plural referents unless the context clearly dictates otherwise. Thus, for example, reference to “a cell” includes a plurality of such cells and reference to “the agent” includes reference to one or more agents known to those skilled in the art, and so forth.

Although the foregoing invention has been described in some detail by way of illustration and Examples for purposes of clarity of understanding, one of skill in the art will appreciate that certain changes and modifications may be practiced within the scope of the appended claims. In addition, each reference provided herein is incorporated by reference in its entirety to the same extent as if each reference was individually incorporated by reference. Where a conflict exists between the instant application and a reference provided herein, the instant application shall dominate.

1. A catalyst system comprising:
a porous polymeric base;
a nanoscale metal catalyst layer disposed on the porous polymeric base; and
a nanoscale electrolyte layer disposed on the metal catalyst layer.

2. The catalyst system of claim 1, wherein the porous polymeric base has a thickness in a range from 100 nm to 100 microns thick.

3. The catalyst system of claim 1, wherein the porous polymeric base comprises a pore size in a range from 10 nm to 10 microns.

4. The catalyst system of claim 1, wherein the porous polymeric base comprises polyethylene, polypropylene, polysulfone, polyimide, polyacrylonitrile, polyvinyl chloride, polyvinylidene fluoride, polyvinyl acetate, polytetrafluoroethylene, or cellulose.

5. The catalyst system of claim 1, wherein the nanoscale metal catalyst layer has a thickness in a range from 1 nm to 100 nm.

6. The catalyst system of claim 1, wherein the nanoscale metal catalyst comprises a transition metal.

7. The catalyst system of claim 6, wherein the transition metal comprises platinum, palladium, copper, rhodium, silver, ruthenium, iridium.

8. The catalyst system of claim 1, wherein the nanoscale electrolyte layer has a thickness in a range from 10 nm to 1,000 nm.

9. The catalyst system of claim 1, wherein the nanoscale electrolyte layer comprises an aqueous solution of a salt of an alkali metal or alkaline earth metal.

10. The catalyst system of claim 1, wherein the catalyst system is monolithic.

11. The catalyst system of claim 1, wherein the system comprises a plurality of component systems.

12. The catalyst system of claim 1, wherein the system comprises one or gas inlets configured to expose the porous polymer to a gas comprising one or more reactants.

13. A method of performing a three-phase catalytic reaction comprising:
providing a catalyst system comprising:
a porous polymeric base;
a nanoscale metal catalyst layer disposed on the porous polymeric base; and
a nanoscale electrolyte layer disposed on the metal catalyst layer; and
delivering one or more reactants to the catalyst system.

14. The method of claim 13, wherein the one or more reactants are delivered proximal to the porous polymer base.

15. The method of claim 13, wherein the one or more reactants are delivered to the catalyst system via the electrolyte layer.

16. The method of claim 13, wherein the one reactant is delivered to the catalyst system via the electrolyte layer and another reactant is deliver to the catalyst system proximal to the porous polymer base.

17. A method of oxidation comprising:
providing a catalyst system comprising:
a porous polymeric base;
a nanoscale platinum catalyst layer disposed on the porous polymeric base; and
a nanoscale electrolyte layer disposed on the platinum catalyst layer; and
delivering oxygen and a substrate for oxidation to the catalyst system.

18. The method of claim 17, wherein oxygen is delivered proximal to the porous polymeric base.

19. The method of claim 17, wherein the substrate is delivered via the electrolyte layer.

20. The method of claim 17, wherein the substrate is formaldehyde.
